(19) United States
(12) Patent Application Publication
(10) Pub. No.: US 2016/0231841 A1
(43) Pub. Date: Aug. 11, 2016

(54) USER INTERFACE

(71) Applicant: Tactus Technology, Inc., Fremont, CA (US)

(72) Inventors: Micah B. Yairi, Fremont, CA (US); Craig M. Ciesla, Fremont, CA (US); Nathaniel Mark Saal, Fremont, CA (US)

(21) Appl. No.: 15/133,867

(22) Filed: Apr. 20, 2016

Related U.S. Application Data
(63) Continuation of application No. 13/908,857, filed on Jun. 3, 2013.
(60) Provisional application No. 61/654,766, filed on Jun. 1, 2012.

(51) Int. Cl. G06F 3/044

(52) U.S. Cl. CPC G06F 3/044

(57) ABSTRACT

One variation of a user interface includes: a substrate defining a fluid channel fluidly coupled to a cavity and including a linear segment parallel to a first direction; a tactile layer including a tactile surface, a deformable region cooperating with the substrate to define the cavity, and an peripheral region coupled to the substrate proximal a perimeter of the cavity; a displacement device coupled to the fluid channel and configured to displace fluid through the fluid channel to transition the deformable region from a retracted setting to an expanded setting, the deformable region tactilely distinguishable from the peripheral region in the expanded setting; a display coupled to the substrate and including a set of pixels arranged in a linear pixel pattern parallel to a second direction nonparallel with the first direction; and a sensor coupled to the substrate and configured to detect an input on the tactile surface.

### CROSS-REFERENCE TO RELATED APPLICATIONS

This application is a continuation of U.S. application Ser. No. 13/908,857, filed 3 Jun. 2013, which claims the benefit of U.S. Provisional Application No. 61/654,766, filed on 1 Jun. 2012, which is incorporated in its entirety by the reference.

This application is related to U.S. patent application Ser. No. 11/969,848, filed on 4 Jan. 2008, U.S. patent application Ser. No. 13/414,589, filed 7 Mar. 2012, U.S. patent application Ser. No. 13/456,010, filed 25 Apr. 2012, U.S. patent application Ser. No. 13/456,031, filed 25 Apr. 2012, U.S. patent application Ser. No. 13/465,737, filed 7 May 2012, and U.S. patent application Ser. No. 13/465,772, filed 7 May 2012, all of which are incorporated herein in their entireties by these references.

### TECHNICAL FIELD

This invention relates generally to touch-sensitive displays, and more specifically to a new and useful user interface in the field of touch-sensitive displays.

### BACKGROUND

Touch and interactive displays have become ubiquitous in consumer electronic devices, from cellular phones to tablets to personal music players, and this technology continues to spread into other devices, from watches to industrial equipment. However, these displays do not typically provide tactile guidance, thus requiring a user interacting with such a display to rely on visual guidance when providing an input. This can both inhibit user input speed and increase erroneous user inputs. Thus, there is a need in the field of touch-sensitive displays to create a new and useful user interface. This invention provides such a new and useful user interface.

### BRIEF DESCRIPTION OF THE FIGURES

FIGS. 1A and 1B are schematic representations of a user interface of the invention;

FIG. 2A-2F are schematic representations in accordance with variations of the user interface;

FIGS. 3A and 3B are schematic representations of one variation of the user interface;

FIG. 4 is a schematic representation of one variation of the user interface;

FIGS. 5A and 5B are schematic representations of one variation of the user interface;

FIGS. 6A-6C are graphical representations in accordance with variations of the user interface.

FIGS. 7A-7C are schematic representations of variations of the user interface;

FIGS. 8A and 8B are schematic representations of variations of the user interface;

FIG. 9 is a schematic representation of one variation of the user interface;

FIGS. 10A and 10B are schematic elevation and plan representations, respectively, of one variation of the user interface; and

FIGS. 11A-11I are a schematic representations of variations of the user interface.

### DESCRIPTION OF THE EMBODIMENTS

The following description of the embodiment of the invention is not intended to limit the invention to these embodiments, but rather to enable any person skilled in the art to make and use this invention.

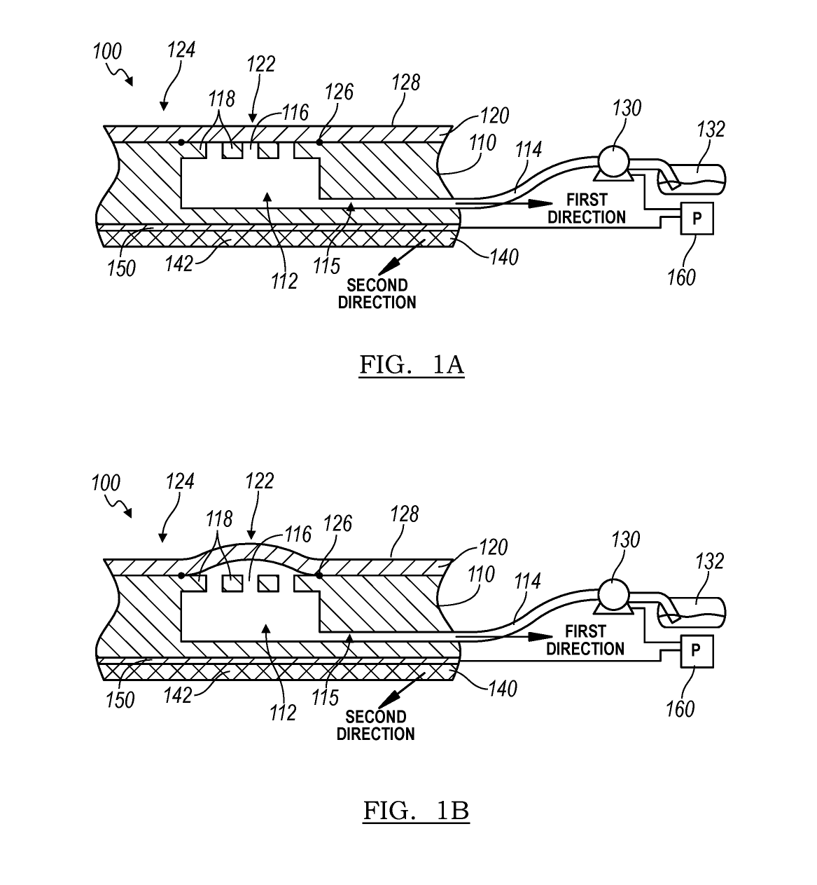

As shown in FIGS. 1A and 1B, a user interface 100 includes: a substrate 110 defining a fluid channel 114 fluidly coupled to a cavity 112, the fluid channel 114 including a linear segment 115 parallel to a first direction; a tactile layer 120 including a tactile surface 128, a deformable region 122 cooperating with the substrate 110 to define the cavity 112, and an peripheral region 124 coupled to the substrate no proximal a perimeter of the cavity 112; a displacement device 130 coupled to the fluid channel 114 and configured to displace fluid through the fluid channel 114 to transition the deformable region 122 from a retracted setting to an expanded setting, the tactile surface 128 at the deformable region 122 tactilely distinguishable from the tactile surface 128 at the peripheral region 124 in the expanded setting; a display 140 coupled to the substrate 110 and including a set of pixels 142 arranged in a linear pixel pattern parallel to a second direction, the second direction nonparallel with the first direction; and a sensor 150 coupled to the substrate no and configured to detect an input on the tactile surface 128.

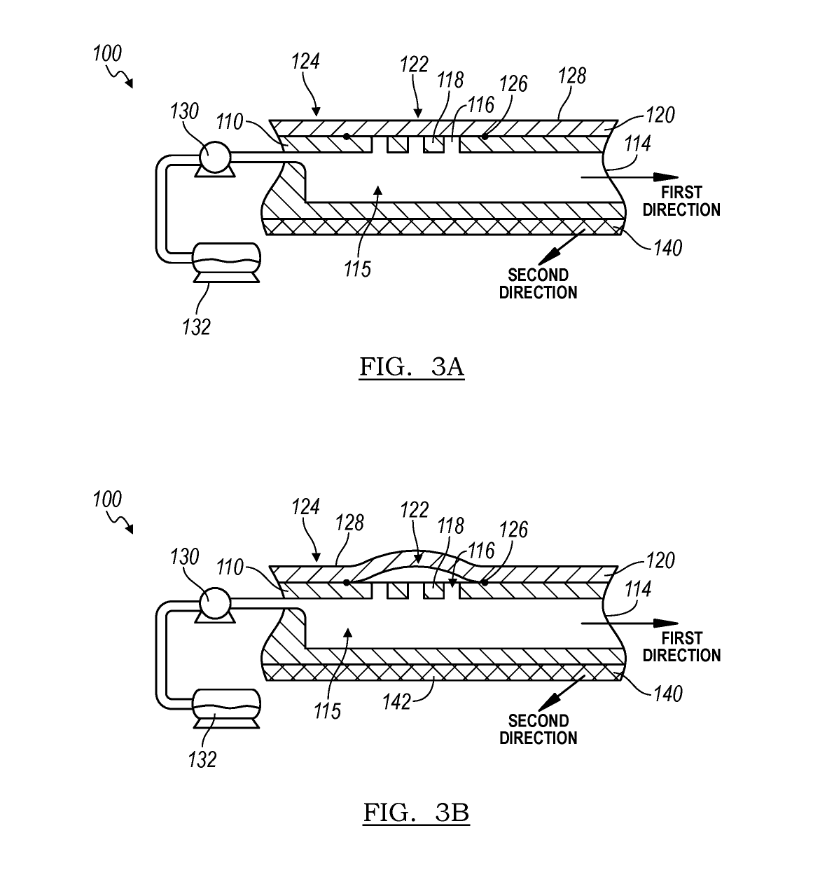

Similarly, as shown in FIGS. 3A and 3B, a variation of the user interface 100 includes: a tactile layer 120 including a tactile surface 128, a deformable region 122, and an peripheral region 124 adjacent the deformable region 122; a substrate 110 coupled to the peripheral region 124 of the tactile layer 120, including a support member 118 adjacent the deformable region 122 and configured to support the deformable region 122 against substantial inward deformation, defining a fluid channel 114 including a linear segment 115 parallel to a first direction, and defining a fluid conduit 116 configured to communicate fluid from the linear segment 115, through the support member 118, to the deformable region 122; a displacement device 130 configured to displace fluid through the fluid channel 114 to transition the deformable region 122 from a retracted setting to an expanded setting, the tactile surface 128 at the deformable region 122 tactilely distinguishable from the tactile surface 128 at the peripheral region 124 in the expanded setting; and a display 140 coupled to the substrate 110 and including a set of pixels 142 arranged in a linear pixel pattern parallel to a second direction, the second direction nonparallel with the first direction.

The user interface 100 defines a deformable region 122 that changes shape and/or vertical position between a retracted setting and an expanded setting to create tactilely distinguishable formations on a tactile surface 128. The user interface 100 thus features tactilely dynamic characteristics controlled through a displacement device 130 that displaces fluid into and out of a cavity 112, via a fluid channel 114, to transition the deformable region 122 between vertical positions flush, above, and/or below the peripheral region 124. The user interface 100 also includes a display 140 that outputs light, in the form of an image, through the substrate 110 and the tactile layer 120. The fluid channel 114 and fluid contained therein may locally optically distort such an image passing through the substrate. For example, the fluid may optically distort (e.g., magnify) adjacent subpixels of one single color or an adjacent pixel gap, and a fluid channel 114 interface may obscure adjacent subpixels of another single color. However, a particular arrangement of the fluid channel 114 (i.e., the linear segment 115) relative to the linear pixel pattern of the display 140 may minimize perceived optical distortion of light output from the display 140 (e.g., preferential distortion of a particular subpixel color), such as in comparison with a fluid channel segment that is parallel or substantially parallel to a linear pixel pattern of a display. For example, nonparallel arrangement of the fluid channel 114 relative to the linear pixel pattern of the display 140 can yield substantially equivalent distortion of light output from all subpixel colors, thereby substantially minimizing perceived local optical distortion of a displayed image and substantially “camouflaging” the linear segment 115 of the fluid channel 114 for a user at a typical viewing distance (e.g., twelve inches between a user's eyes and the display 140).

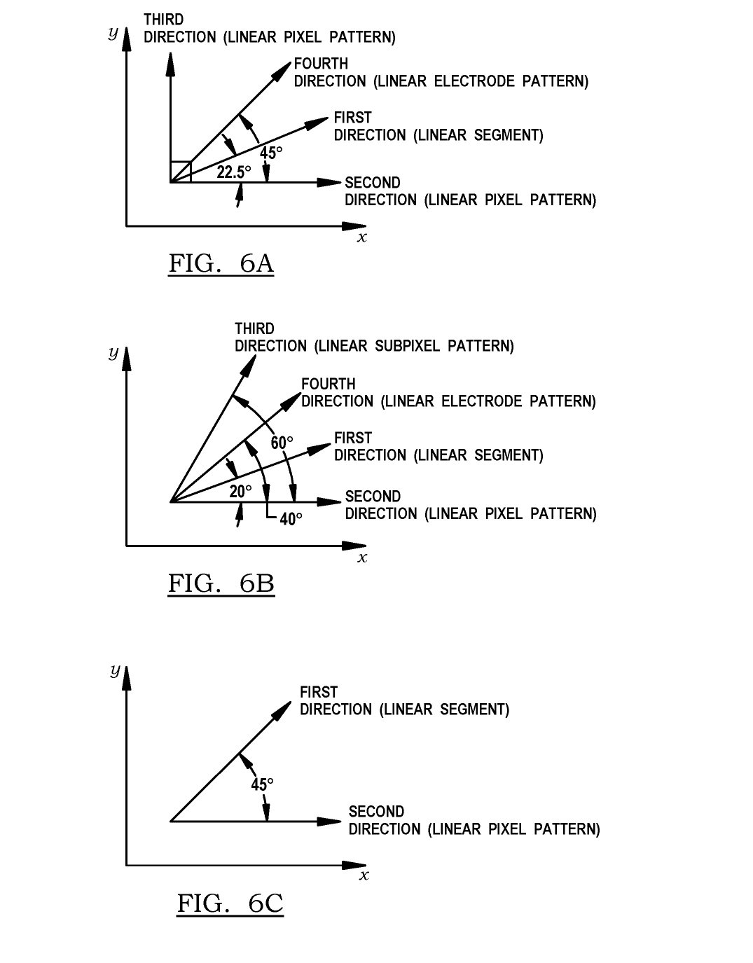

Generally, the linear segment 115 is linear in a first direction that defines an acute (or obtuse) angle with the second direction that is parallel to the linear pixel pattern of the display 140, as shown in FIG. 6C. This arrangement can substantially minimize reflection, refraction, diffraction, and/or scattering effects of light emitted from multiple pixels or subpixels of various colors adjacent an edge of the linear segment 115, thereby minimizing perceived optical distortion of light output from the display 140. The arrangement can similarly minimize distortion of light emitted from multiple pixels or subpixels of various colors along and/or across the linear segment 115. This can reduce the ease with which a user may optically resolve (i.e., notice visually) the linear segment 115 when an image is rendered on the display 140.

The display 140 of the user interface 100 is coupled to the substrate no and includes the set of pixels 142 repeated along the second direction, thereby defining the linear pixel pattern along the second that is nonparallel with the first direction. The display 140 can be an in-plane-switching (IPS) LED-backlit color LCD display, a thin-film transistor liquid crystal display (TFT-LCD), an LED display, a plasma display, a cathode ray tube (CRT) display, an organic LED (OLED) display, or other type of display. The display 140 can also or alternatively incorporate any other type of light source, such as an OLED, cold cathode fluorescent lamp, hot cathode fluorescent lamp, external electrode fluorescent lamp, electroluminescent panel, incandescent panel, or any other suitable light source. Furthermore, the display 140 can incorporate plane-to-line switching, twisted nematic (TN), advanced fringe field switching (AFFS), multi-domain vertical alignment (MVA), patterned vertical alignment (PVA), advanced super view (ASV), or any other suitable switching technique.

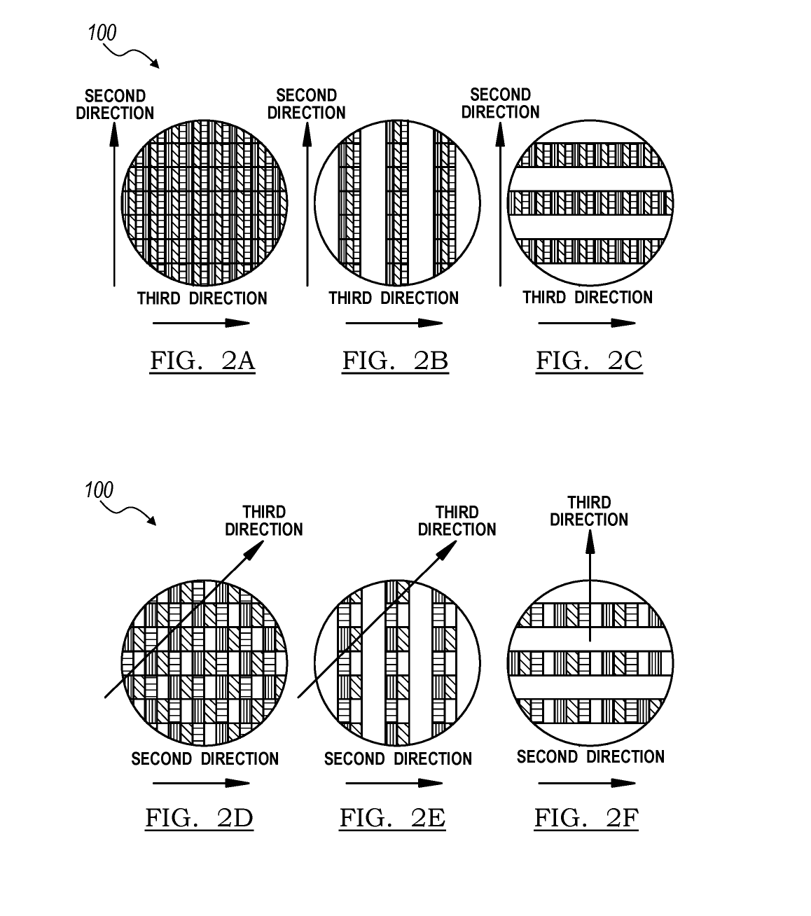

Each pixel 142 in the display 140 can include a set of red, green, and blue (RGB) subpixels, though each pixel 142 can additionally or alternatively include a white (W) subpixel or a subpixel of any other color. For example, each pixel in the set of pixels 142 can include a set of color subpixels, wherein each color subpixel in the set of color subpixels is configured to output a discrete color of light (i.e., filter light output from a backlight). Each pixel in the display 140 can be identical in subpixel composition and arrangement, though the display can alternatively include multiple different types of pixels with different subpixel compositions and arrangements. The pixels can be patterned across the display 140 in a pixel pattern that is linear in at least the second direction. The pixels can also be patterned (i.e., repeated) along a third (linear) direction, such as perpendicular to the second direction to form a rectilinear pixel array as shown in FIGS. 2A-2F. As shown in FIGS. 2A, 2B, 2C, and 2F, the arrangement of subpixels within each pixel 142 can yield a display with uninterrupted alignment of same-color subpixels in at least one direction for vertically- and horizontally-patterned pixels. In one example shown in FIG. 2A, arrangement of subpixels within each pixel can yield a display with uninterrupted vertical alignment of red subpixels. In another example shown in FIGS. 2D and 2E, arrangement of subpixels within each pixel can yield a display with off-axis repetition of subpixels even for a rectilinear pixel array. In yet another example shown in FIG. 2D, arrangement of subpixels within each pixel can yield a display with red subpixel repetition at approximately 60° from horizontal due to a rectilinear RGBW (red, green, blue, white) composition of each pixel. However, the pixels can be patterned in any other way and can include any other number and color subpixels in any other arrangement. The display 140 can also include pixels with same-color subpixels that repeat at any other angle, density, or distribution.

The display 140 can output an image aligned with the deformable region, as described in U.S. patent application Ser. No. 13/414,589, filed on 7 Mar. 2012, which is incorporated herein in its entirety by the reference. In one example, the display 140 can output a “swipe to unlock” image aligned with the deformable region that defines a linear elevated ridge in the expanded setting. In this example, the sensor can detect a swipe gesture along the raised linear ridge, and a processor coupled to the sensor can respond to the swipe gesture by “unlocking” an electronic device that includes the user interface 100. However, the display can output any other image or portions of an image, and the sensor 150 and a processor can capture and respond to inputs adjacent various portions of the image in any other suitable way.

The substrate 110 of the user interface 100 defines the fluid channel 114 that is fluidly coupled to the cavity 112, wherein the fluid channel 114 includes a linear segment 115 parallel to a first direction. The substrate 110 can be a translucent or transparent material, such as glass, chemically-strengthened alkali-aluminosilicate glass, polycarbonate, acrylic, polyvinyl chloride (PVC), glycol-modified polyethylene terephthalate (PETG), a silicone-based elastomer, urethane-based elastomers, allyl diglycol carbonate, cyclic olefin polymer, or any other suitable material or combination of materials. The substrate 110 can be substantially planar and substantially rigid, thereby retaining the tactile layer 120 at the peripheral region 124 in planar form. Alternatively, substrate 110 can be relatively extensible (and/or elastic, elastic, flexible, stretchable, or otherwise deformable) and mounted over the display 140, wherein the display 140 is relatively rigid and retain the substrate 110 in planar form. However, the substrate 110 can be of any other form, such as curvilinear, convex, or concave. The tactile layer 120 can be joined, adhered, fastened, retained, or otherwise coupled across an outer broad face of substrate no, and the display 140 can be joined, bonded, adhered, fastened, retained, or otherwise coupled across an inner broad face of the substrate 110 opposite the outer broad face. (Hereinafter, ‘outer broad face’ may refer to the broad face of a component nearest the tactile surface 128, and ‘inner broad face’ may refer to the broad face of a component furthest from the tactile surface 128.) However, the inner broad face or outer broad face of the substrate no can alternatively be joined, bonded, adhered, fastened, retained, or otherwise coupled to a sensor 150. For example, the sensor 150 can be arranged between the substrate no and the display 140 or between the substrate no and the tactile layer 120.

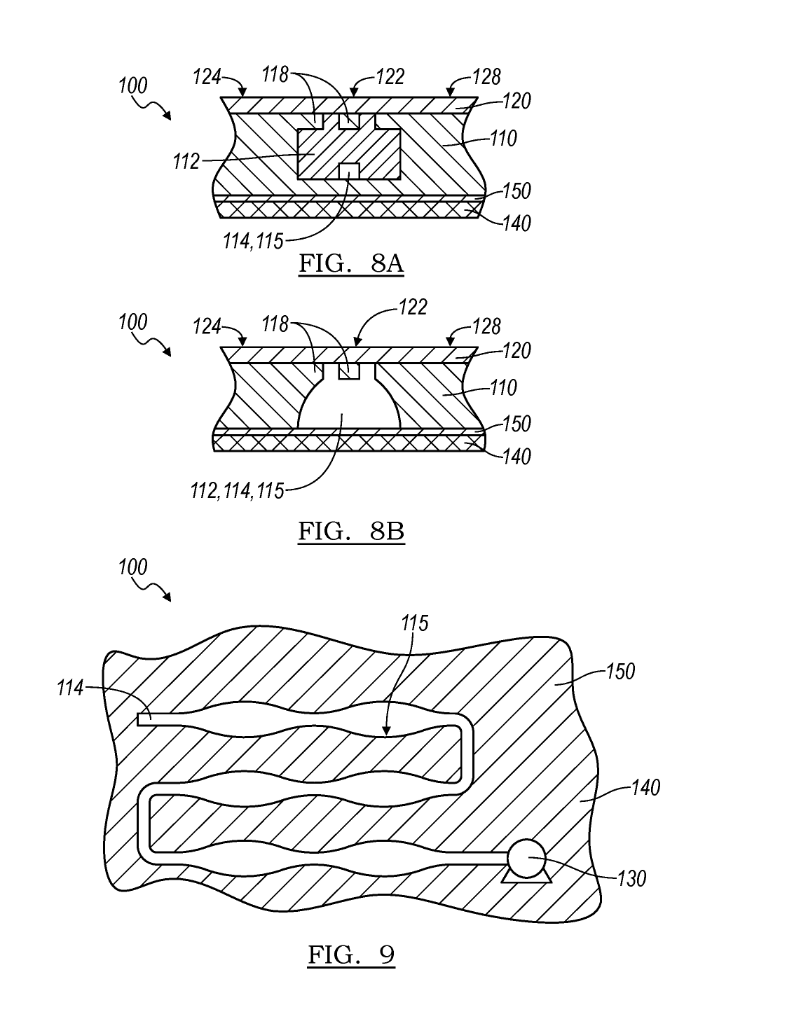

The substrate no can fully enclose the fluid channel 114. For example, the channel can be cut, machined, molded, formed, stamped, or etched into a first layer of the substrate no, and the first layer of the substrate no can be bonded to a second layer of the substrate no to enclose the channel and thus form the enclosed fluid channel 114. Alternatively, a channel can be cut, machined, molded, formed, stamped or etched onto the inner broad face of the substrate 110 opposite the tactile layer 120, and the display 140 or sensor 150 coupled to the inner broad face of the substrate no can cooperate with the substrate no to enclose the fluid channel 114, as shown in FIG. 8B. However, the substrate 114 can define the fluid channel 114 independently of or in cooperation with any other element.

The substrate 110 can also define the cavity 112 that is coupled to the fluid channel 114 and that is adjacent the tactile layer 120 at the deformable region 122. The cavity 112 can communicate fluid from the fluid channel 114, through a portion of the substrate no, to the inner broad face of the tactile layer 120 at the deformable region 122. The cavity 112 can therefore communicate fluid pressure changes within the fluid channel 114 to the deformable region 122 to expand and retract the deformable region 122. As shown in FIG. 1A, the cavity 112 can be of a cross-sectional area greater than that of the fluid channel 114. Alternatively, the cavity 112 can have a cross-sectional area that is less than that of the fluid channel 114, or the fluid channel 114 can cooperate with a fluid conduit 116 to define the cavity 112, as described below and shown in FIG. 8B. As in the variation of the user interface 100, the substrate no can alternatively define the cavity 112 that is in-line and/or continuous with the fluid channel 114, such as of the same or similar cross-section as the fluid channel 114.

The substrate 110 can additionally or alternatively define a support member 118 adjacent the deformable region 122 and configured to support the deformable region 122 against inward deformation in response to a force applied to the tactile surface 128 at the deformable region 122. Generally, the support member 118 can define a hard stop for the tactile layer 120, thus resisting inward deformation of the deformable region 122 due to a force (e.g., an input) applied to the tactile surface 128. Alternatively, the support member 118 can define a soft stop that functions to augment a spring constant of the tactile layer 120 at the deformable region 122 once an input on the tactile surface 128 inwardly deforms the deformable region 122 onto the support member 118. However, the support member 118 can function in any other way to resist substantial (inward) deformation of the tactile layer 128. The support member 118 can be in-plane with the outer broad face of the substrate 110 adjacent the peripheral region 124 such that the member resists inward deformation of the deformable region 122 past the plane of the peripheral region 124. However, the support member 118 can be of any other geometry or form.

In one implementation, the support member 118 defines a fluid conduit 116 that communicates fluid from the cavity 112, through the support member 118, to the inner broad face of the deformable region 122. The fluid conduit 116 can be formed by etching, drilling, punching, stamping, molding, or forming, or through any other suitable manufacturing process. In this implementation, the support member 118 can define the fluid conduit 116 that is of a cross-sectional area less than that of a single pixel of the display 140. However, the support member 118 can define the fluid conduit 116 that is of any other cross-sectional area, size, shape, or geometry.

In another implementation, the substrate defines the fluid conduit 116 configured to communicate fluid from the linear segment 115, through the support member 118, to the deformable region 122, wherein the fluid conduit 116 and a portion of the linear segment 115 cooperate to define the cavity 112, as shown in FIGS. 3A, 3B, and 8B. In this implementation, the fluid channel 114 can communicate fluid directly between the fluid conduit 116 and the displacement device 130 to transition the deformable region 122 between the retracted and expanded settings.

In yet another implementation, the substrate 110 defines the support member 118 that extends into the cavity 112 adjacent the deformable region 122, as shown in FIG. 1A. However, the substrate 110 can include any other component or feature, can be manufactured through any one or more processes, can be of any other form or geometry, and can include any number of fluid channels, cavities, and/or fluid conduits.

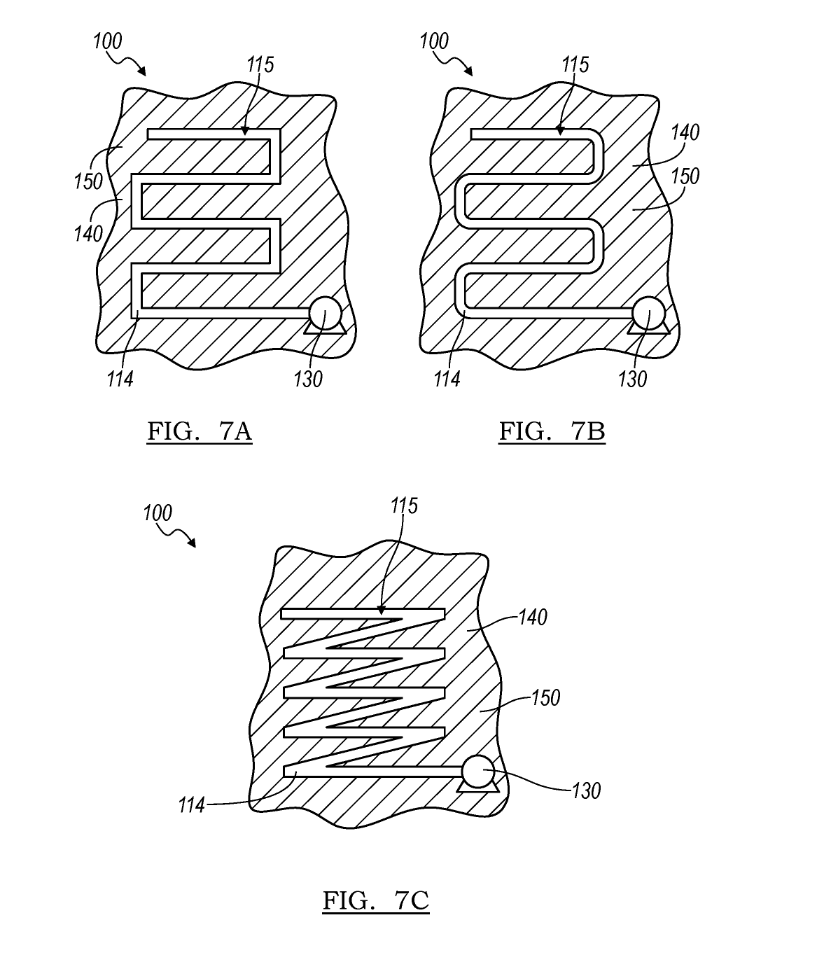

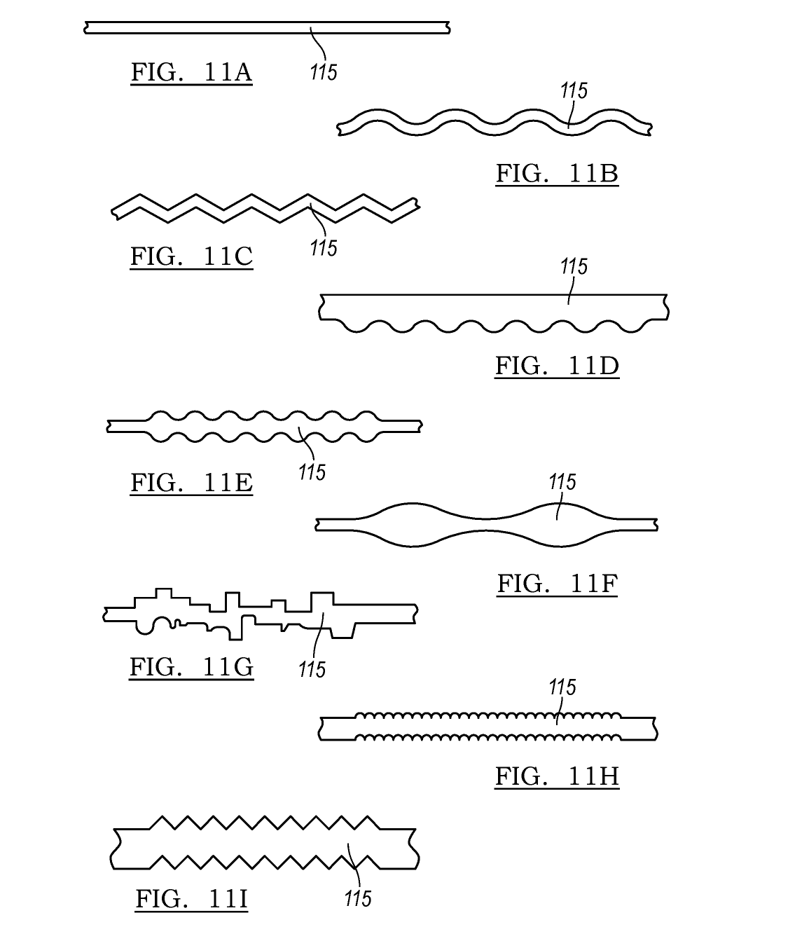

The fluid channel 114 includes the linear segment 115 that is linear in the first direction. The linear segment 115 can be of a rectilinear (shown in FIGS. 8A), trapezoidal, curvilinear, circular, semi-circular (shown in FIG. 8B), ovular, or elliptical cross-section or of any other suitable geometry or cross-section. For example, the fluid channel 114 can include multiple linear segments, as shown in FIGS. 7A-7C, and the geometry and/or cross-section of each linear segment can be tailored to a local pixel geometry of the display 140 in order to substantially minimize perceived optical distortion of a portion of an image output by the display 140 and transmitted through the substrate 110 proximal the local linear segment. Furthermore, rather than sharp corners or edges, the linear segment 115 can include concave or convex fillets of constant or varying radii at various edges or corners. In this implementation, the fillets can minimize perceived optical distortion by softening otherwise sharp corners and edges. As shown in FIG. 11A, the linear segment 115 can define parallel walls of a straight (e.g., linear) form. Alternatively, the linear segment 115 can be of varying width along and/or define an oscillatory profile along the first direction. In various examples, the linear segment 115 defines mirrored sinusoidal or wave-like walls (shown in FIGS. 9, 11E, 11F, and 11H), parallel sinusoidal or wave-like walls (shown in FIG. 11B), mirrored crenulated walls (shown in FIG. 11I), parallel crenulated walls (shown in FIG. 11C), or pseudorandomly-stepped walls (shown in FIG. 11G). In this implementation, a wall of the linear segment 115 can oscillate or vary in profile longitudinally and thus pass adjacent subpixels of different colors, and a varying-form wall of the linear segment 115 can thus limit preferential optical distortion of subpixels of one particular color over subpixels of another color within the display 140. The linear segment 115 can also include one longitudinal edge that is straight and another defining a curvilinear geometry (as shown in FIG. 11D), though the linear segment 115 can define any other straight, varying, or oscillatory form. Therefore, as in the foregoing implementation, the linear segment 115 of the fluid channel 114 can be defined as a varying cross-sectional geometry swept linearly through the substrate 110 along (i.e., parallel to) the first direction, and a wall and/or edge of the linear segment 115 may be non-parallel to the first direction, parallel to the second direction, and/or parallel to the third direction.

The linear segment 115 can additionally or alternatively be of a substantially small cross-sectional area, such as relative to the size of a pixel or a thickness of the substrate. In this implementation, the minimal cross-section of the linear segment can limit perceived optical distortion of light at a boundary or interface, such as at a junction between the fluid and the fluid channel 114. The cross-sectional geometry and/or the minimal cross-sectional area of the linear segment 115 can thus render the linear segment 115 substantially optically imperceptible to a user and/or limit perceived optical distortion of light transmitted from the display, such as to less than a just noticeable difference at a typical working distance of twelve inches between the display 140 and an eye of the user at a viewing angle of less than 10°. The linear segment 115 can also be substantially optically imperceptible to a user and/or feature perceived optical distortions less than a just noticeable difference at extended viewing angles, such as −75° to +75°, or at a particular viewing angle, such as 7°.

Fluid contained within the fluid channel 114, the cavity 112, and/or the fluid conduit 116 can be of a refractive index substantially similar to a refractive index of the substrate 110 and/or the tactile layer 120, which can reduce perceived optical distortion at a junction between the fluid and the fluid channel and/or junction between the fluid and the tactile layer by limiting light refraction, reflection, diffraction, and/or scattering across the junction(s). For example, fluid contained within the fluid channel 114, the cavity 112, and the fluid conduit 116 can be selected for an average refractive index (i.e., across wavelengths of light in the visible spectrum) that is substantially identical to an average refractive index of the substrate 110 and/or of a chromatic dispersion similar to that of the substrate no.

As described above, features and geometries of the fluid channel 114, the linear segment 115, the cavity 112, the substrate 110, and/or the tactile layer 120 can limit light scattering, reflection, refraction, and diffraction of an image transmitted from the display 140 to a user. However, features and geometry of the foregoing components can additionally or alternatively limit directional or preferential light transmission or emission through the substrate no and/or the tactile layer 120 in favor of more uniform scattering, diffraction, reflection, and/or refraction of light through a portion of the substrate 110 and/or a portion of the tactile layer 120.

The linear segment 115 of the fluid channel 114 can be defined as any of the foregoing cross-sectional geometries swept linearly through the substrate 110 parallel to the first direction. The linear segment 115 can also pass through the substrate 110 at substantially constant depth relative to the outer broad face of the substrate no, the first direction thus parallel to a plane of at least a portion of the outer broad face of the substrate 110. However, the fluid channel 114 and/or the linear segment 115 can pass through the substrate 110 at varying, undulating, or stepped depths through the substrate.

Generally, as described above, the first direction is nonparallel with the second direction such that the linear segment 115 is misaligned with the linear pixel pattern. The linear segment 115 can also be misaligned with a subpixel pattern or subpixel color repetition within the display 140. In one configuration of one example in which the display includes a linear pixel pattern in which same-color subpixels are adjacent, such as shown in FIGS. 2A and 2B, the linear segment 115 is parallel with a series of same-color subpixels. In this configuration, an edge of the linear segment 115 (i.e., substrate/fluid boundary) can be aligned with a single subpixel of a particular color and thus selectively distort (e.g., magnify, non-uniformly disperse, etc.) a line of subpixels of the particular color. Furthermore, visual alignment of the linear segment 115 with a row of same-color pixels can be dependent on a user viewing angle, wherein a low viewing angle (e.g., >10°) yields perceived optical distortion of a row of subpixels of one particular color (e.g., red), wherein an intermediate viewing angle (e.g., 10°-30°) yields perceived optical distortion of a row of subpixels of one particular color (e.g., green), and wherein a high viewing angle (e.g., <30°) yields perceived optical distortion of a row of subpixels of yet another particular color (e.g., blue). In another configuration of this example, the linear segment 115 can be misaligned with the linear pixel pattern at a small included angle (e.g., less than 10° with the second direction). In this configuration, an edge of the linear segment 115 can align substantially with sets of linearly adjacent red, green, and blue subpixels, such as ten adjacent red pixels, followed by ten adjacent green pixels, followed by ten adjacent blue pixels, and repeating. In this configuration, the linear segment 115 can optically distort repeating sets of linearly adjacent subpixels, thus yielding selective perceived local optical distortion (e.g., magnification) of a particular subpixel color, which may be visually perceptible to a user at a typical viewing distance.

As an angle between the linear segment 115 and the linear pixel pattern increases, a length of each set of linearly adjacent red, green, and blue subpixels optically distorted by the linear segment 115 decreases to a minimum number of adjacent same-color subpixels (e.g., one). For example, for a subpixel arrangement shown in FIG. 2A, when the first direction intersects the second direction at or near 60°, the linear segment 115 may equally optically distort each color in an adjacent red-green-blue subpixel pattern, thereby minimizing selection distortion of a particular subpixel color. For the subpixel arrangement shown in FIGS. 2A and 2B, an ‘optimum’ angle between the first and second directions may be related to a length-to-width ratio of each pixel (or subpixel). In one example, for a square subpixel, the ‘optimum’ angle between the first and second directions can be 45°. In another example, for a subpixel with a height to width ratio of ˜1.7, the ‘optimum’ angle between the first and second directions can be ˜60° (i.e., tan (60°=1.732). However, for the display 140 that includes a set of rectilinear pixels in which each pixel defines a short face and a long face, the second direction can be parallel to the short face of the set of pixels, and the first direction can be parallel to a diagonal across the short face and the long face of each pixel in the set of pixels.

For pixels (and subpixels) patterned linearly across the display 140, as the angle between the first and second directions approaches 90°, the linear segment 115 of the fluid channel can optically distort (e.g., magnify) a gap between pixels (or subpixels). Because the gap between pixels (or subpixels) is not lighted and may be colored black, white, or gray, the linear segment 115 may optically magnify or distort a black, white, or gray line on the screen in configurations in which the linear segment 115 is substantially parallel to a gap between pixels (or subpixels). Therefore, for the pixel configurations shown in FIGS. 2A and 2b, for included angels between the first and second directions that substantially exceed 45°, black, white, and/or gray lengths may become optically visible along the linear segment.

In another implementation, the first direction can (equally) bisect the second direction and a third direction, wherein the second direction is parallel to the linear pixel pattern defined by nearest adjacent same-color subpixels, and wherein the second direction is parallel to a second linear pixel pattern defined by next-closest same-color subpixels. In this implementation, the linear segment 115 (via the first direction) can thus be substantially parallel to a pattern of subpixels defined by linearly adjacent different colors, such as a repeating pattern of red, green, and blue subpixels. This configuration can substantially minimize perceived preferential optical distortion of one or a subset of colors in each pixel.

In another example of the foregoing implementation, each pixel can include a two-by-two array of red, green, blue, and white subpixels, and a set of pixels 142 patterned longitudinally along one axis of the two-by-two array and patterned in a mirrored configuration laterally along another axis of the two-by-two array to define the display 140, such as shown in FIG. 2D. In this example, for subpixels that are substantially square, the second and third directions can be approximately 45° above and below the horizontal plane, each of the second and third directions thus parallel to nearest same-color subpixels. Therefore, in this example, the first direction can be parallel to horizontal and thus equally bisect the second and third directions. In this configuration, the linear segment 115 can thus be substantially parallel to a red, green, blue, and white repeated subpixel pattern, which may yield substantially minimal preferential distortion of one or a subset of colors of the display.

In yet another example of the foregoing implementation, each pixel can include a two-by-two array of red, green, blue, and white subpixels, and a set of pixels 142 patterned longitudinally and laterally along vertical and horizontal axes of the two-by-two arrays to define the display 140, such as shown in FIG. 2E. In this example, linear repetition of a first subset of adjacent color pixels (e.g., red and green) can occur along the second direction (e.g., parallel to horizontal), linear repetition of a second subset of adjacent color pixels (e.g., red and blue) can occur along the third direction (e.g., parallel to vertical), and linear repetition of a third subset of adjacent color pixels (e.g., red and white) can occur along a fourth direction (e.g., 60° above horizontal). Therefore, in this example, the first direction can be approximately 30° above horizontal, which bisects the second and fourth directions and is nonparallel the third direction. In this configuration, the linear segment 115 can thus be substantially parallel to a red, green, blue, and white repeated subpixel pattern, which may yield substantially minimal preferential distortion of one or a subset of colors of the display.

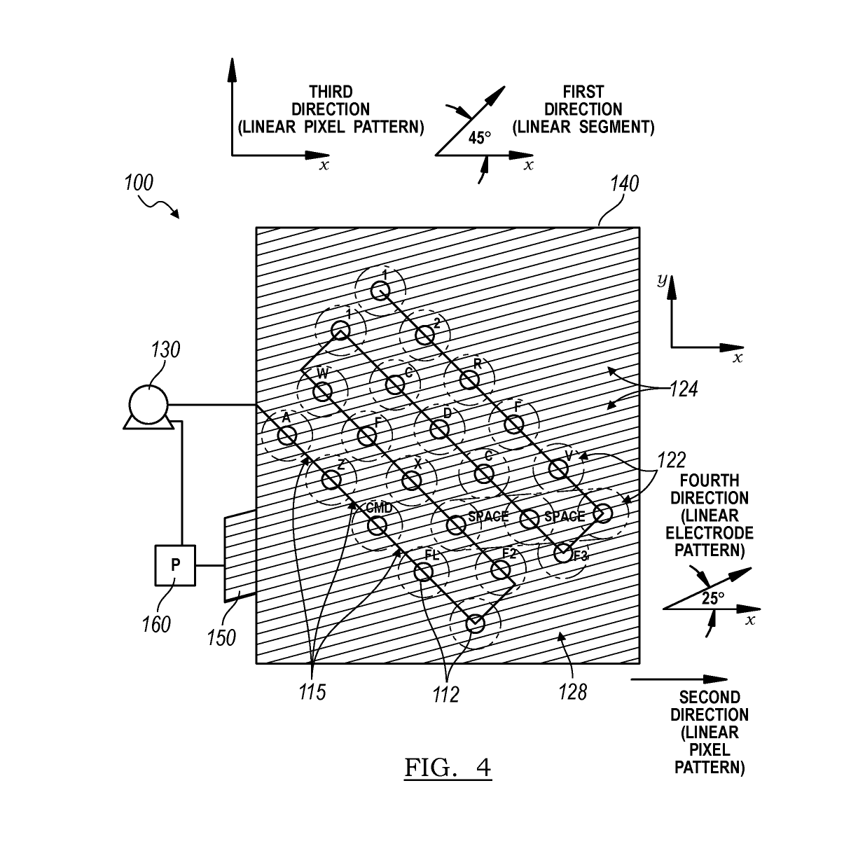

Therefore, in one example of the foregoing implementations shown in FIG. 4, wherein the display 140 includes pixels patterned in the second direction that is parallel to an X-axis and patterned in a third direction that is parallel to a Y-axis, the first direction bisects the second and third directions at 45°. In another example (similar to that shown in FIG. 6B), the display 140 includes pixels patterned in the second direction that is along an X-axis with subpixel repetition along a third direction that is 60° from the X-axis, and the first direction bisects the second and third directions at 30° from the X-axis. In another example shown in FIG. 6A (and similarly in FIG. 4), the display 140 includes pixels patterned in the second direction that is along an X-axis and patterned in a third direction that is along a Y-axis, the sensor 150 includes electrodes patterned linearly in a fourth direction that bisects the second and third directions at 45° from the X-axis, and the first direction bisects the second and fourth directions at 22.5°. However, the linear segment 115 of the fluid channel 114 can cooperate with the linear pixel pattern and/or the linear sensor electrode pattern to define any other included angle.

As shown in FIG. 4, the substrate no can include multiple linear segments that define a serpentine fluid channel of a substantially rectilinear path. For example, the fluid channel 114 can include a set of parallel linear segments connected via perpendicular linear segments to define a serpentine fluid path. Each linear segment of the serpentine path can be orthogonal to an adjacent linear segment, as shown in FIG. 7A. However, adjacent linear segments of the fluid channel 114 can form any other included angle (as shown in FIG. 7C) in order to maintain nonparallelism between each linear segment and a linear pixel pattern and/or a linear sensor electrode pattern throughout the user interface 100. Alternatively, the substrate no can include linear segments that define any other structure or path, such as a tree-like arrangement of fluid channel segments.

As shown in FIG. 7B, intersections of various linear segments can also be filleted to minimize perceived optical distortions, such as Fresnel reflections, that may occur at sharp junctions between materials, such as between a face of the fluid channel 114 and the fluid proximal a corner of the fluid channel 114. However, the substrate no can define the fluid channel 114 that is of any other geometry and includes any other number of linear or nonlinear sections arranged in any other format or according to any other schema.

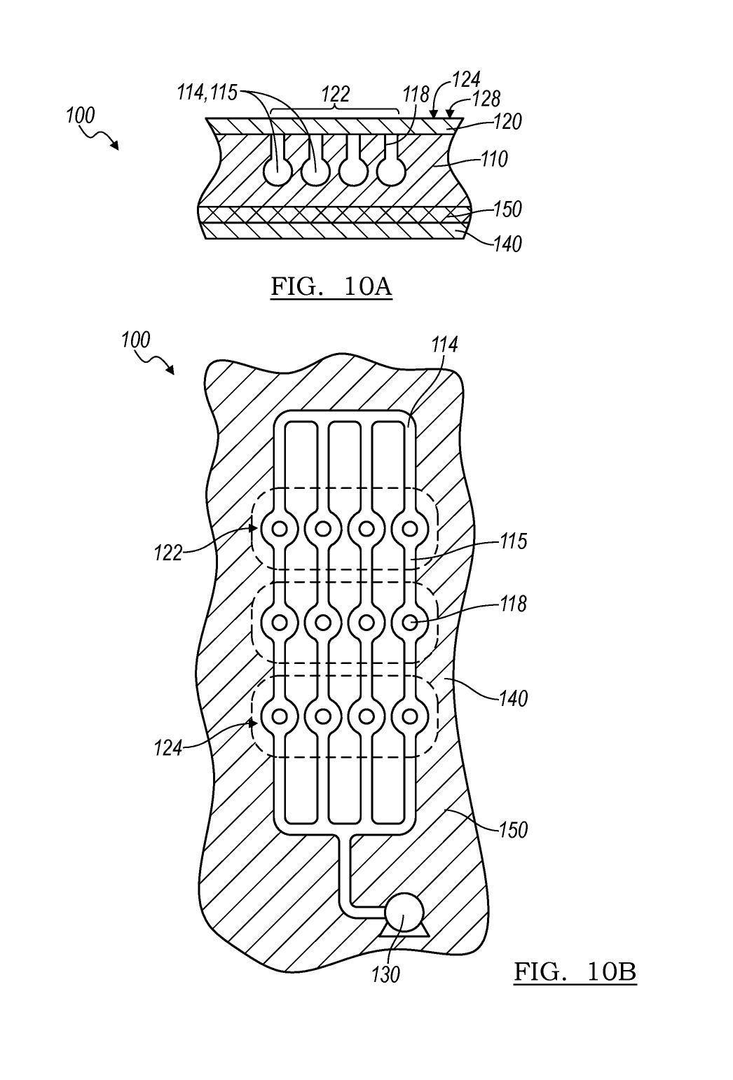

As shown in FIGS. 10A and 10B, in one implementation in which the fluid channel 114 includes several closely-spaced adjacent linear segments of substantially small cross-section (e.g., an array of connected microfluidic channels), the fluid channel 114 can polarize light transmission and/or emission through the substrate 110. Furthermore, due to pixel and/or subpixel arrangement, the display 140 can output polarized light such that orthogonal arrangement of the linear segments of the fluid channel to the linear pixel pattern may substantially obscure light transmission and/or emission through the substrate 110. Therefore, in this implementation, linear segments of the fluid channel 114 can be arranged at substantially less than 90° to the linear pixel pattern. Generally, the linear segments of the fluid channel 114 can be arranged at an angle that sufficiently compromises selective local distortion of particular subpixel colors and internal light reflectance through polarization effects. For example, the first direction can intersect the second direction at 5°, thereby permitting 85% light transmission through the substrate proximal the fluid channel 114 with optically imperceptible linear segments at a viewing distance of twelve inches between −30° and +30° viewing angles. In another example, an angle of 45° between the first and second directions can permit 50% light transmission with optically imperceptible linear segments at a viewing distance of twelve inches between −60° and +60° viewing angles. However, the fluid channel 114 can include any other number of linear segments of any other size, spacing, or arrangement relative to the linear pixel pattern of the display 140. Furthermore, the substrate 110 can define the fluid channel 114 relative to the display 140 to minimize directional polarization of light transmitted or emitted through the substrate 110 such that a perceived intensity of transmitted or emitted light does not substantially change as the user interface 100 is rotated relative to a user.

However, in other implementations, the first and second directions are substantially aligned such that the linear segment 115 and the linear pixel pattern of the display 140 are substantially parallel. In one implementation, the cross-section of the linear segment 115 can incorporate heavy filleting to avoid sharp corners. In another implementation, the fluid channel 114 includes nonlinear sections defining arcuate, elliptical, spline, Bezier, or any other nonlinear path through the substrate.

In yet other implementations, the substrate 110 can be physically coextensive with the display 140 and/or the sensor 150. For example, the fluid channel 114 can be formed into an inner broad face of the tactile layer 120 or otherwise substantially defined on or within the tactile layer 120. In this example, the cavity 112 can also be partially defined by a recess on the inner broad face of the tactile layer 120 at the deformable region 122. In this example, the tactile layer 120 can be bonded or otherwise attached to the substrate 110 at the peripheral region 124, which rigidly retains the peripheral region 124 as the deformable region 122 is transitioned between setting. However, the substrate 110, cavity 112, fluid channel 114, etc. can be configured, arranged, and/or formed in any other suitable way.

The tactile layer 120 of the user interface 100 includes the tactile surface 128, a deformable region 122 cooperating with the substrate 110 to define the cavity 112, and a peripheral region 124 coupled to the substrate proximal a perimeter of the cavity 112. As described in U.S. patent application Ser. No. 12/652,708, filed on 22 Mar. 2010, which is incorporated herein in its entirety by this reference, the tactile layer 120 can be selectively coupled (e.g., attached, adhered, mounted, fixed) to the substrate 110 at the peripheral region 124 such that the deformable region 122 can transition between vertical positions, relative to the peripheral region 124, given a fluid pressure change within the fluid channel 114. As described below, the displacement device 130 can manipulate fluid pressure within the cavity 112, via the fluid channel 114, to transition the deformable region 122 between vertical positions. The peripheral region 124 can be coupled to the outer broad face of the substrate no at an attachment point 126, along an attachment line, or across an attachment area adjacent the perimeter of the cavity 112. The peripheral region 124 of the tactile layer 120 can be coupled to the substrate 110 via gluing, bonding (e.g., diffusion bonding), surface activation, a mechanical fastener, or by any other suitable means, mechanism, or method.

The tactile layer 120 can be a translucent or substantially transparent material, thereby enabling transmission of light therethrough, such as from the display 140. The tactile layer 120 can be of a single substantially extensible and/or elastic (and/or flexible, stretchable, or otherwise deformable) material across both the deformable region 122 and the peripheral region 124. Alternatively, the tactile layer 120 can be selectively extensible and elastic, such as across all or a portion of the deformable region 122 or proximal a perimeter of the cavity 112. The tactile layer 120 can also be of uniform thickness across the deformable and peripheral regions 122, 124. However, the tactile layer 120 can be of any other form, thickness, material, elasticity, extensibility, or composition, etc.

As described above, one implementation includes a fluid conduit 116 that communicates fluid from the cavity 112, through the support member 118, to the inner broad face of the deformable region 122, the thickness of the tactile layer 120 can be approximately equal to or greater than a (maximum cross-sectional) width of the fluid conduit 116. In this configuration, the thickness of the tactile layer 120 at the deformable region 122 can thus limit excursion of the tactile layer 120 into the fluid conduit 116 in response to a force applied to the tactile surface 128. Similarly, the thickness of the tactile layer 120 can be approximately equal to or greater than a maximum width dimension of the cavity 112 adjacent the inner broad face of the tactile layer 120, which can similarly limit excursion of the tactile layer 120 into the cavity 112 in the presence of a force applied to the tactile surface 128.

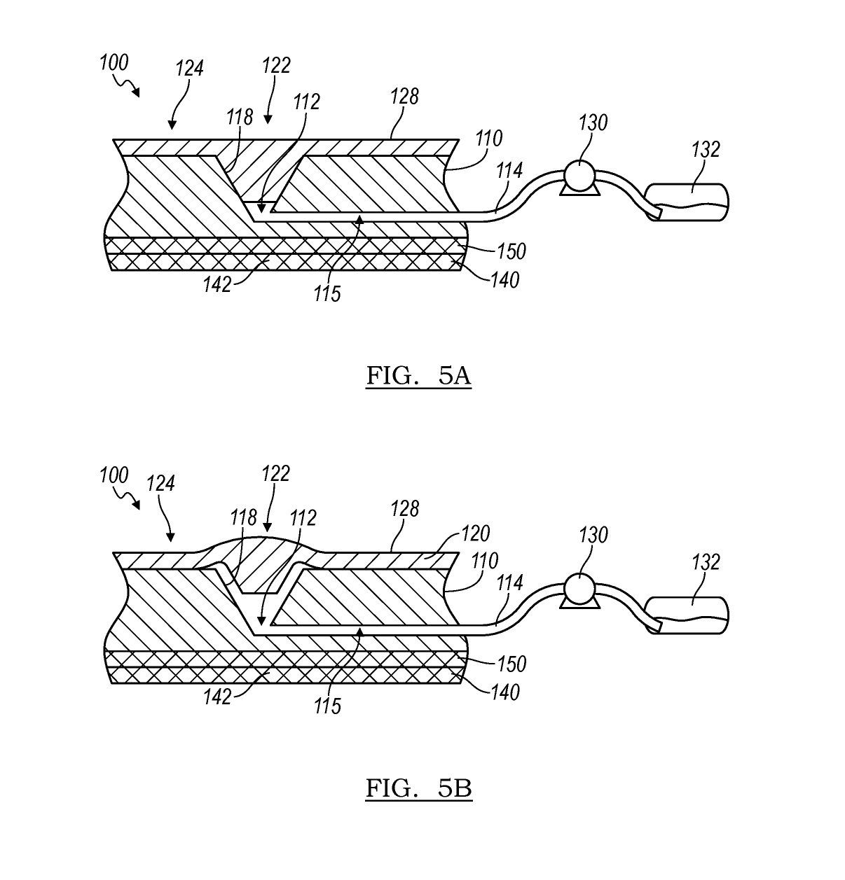

The tactile layer 120 can also be of non-uniform thickness across the deformable and peripheral regions 122, 124. In one implementation, the deformable region 122 includes a column that extends into the cavity 112, as shown in FIGS. 5A and 5B and described in U.S. patent application Ser. No. 13/481,676, filed on 25 May 2012, which is incorporated herein in its entirety by this reference. For example, the deformable region 122 can include a tapered column configured to seat on a tapered wall of the cavity 112, such as in the retracted setting or when the deformable region is depressed, to support the tactile surface 128 at the deformable region 122 against inward deformation in response to a force applied to the tactile surface 128. Thus, the cavity 112 can cooperate with the column to function as the support member 118 described above.

In another implementation, the deformable region 122 includes a reduced-cross-section portion along the perimeter of the cavity 112, wherein the reduced-cross-section portion absorbs a substantial degree of deformation of the deformable region 122 when transitioned between the expanded and retracted settings.

The tactile surface 128 can be continuous across the deformable and peripheral regions 122, 124, as shown in FIG. 3A and 3B. The tactile layer 120 can be of a single material or a composition of multiple sublayers of the same or different materials. For example, the tactile layer 120 can include several sublayers of the same or different materials, such as a silicone elastomer sublayer bonded to a Poly(methyl methacrylate) (PMMA) sublayer. Alternatively, the tactile layer 120 can be of any one or more sheets or sublayers of polycarbonate, acrylic, polyvinyl chloride (PVC), or glycol-modified polyethylene terephthalate (PETG). However, the tactile layer 120 can be of any other geometry or material and can exhibit any other suitable optical, chemical, or mechanical property.

The displacement device 130 of the user interface 100 is coupled to the fluid channel 114 and is configured to displace fluid through the fluid channel 114 to transition the deformable region 122 from the retracted setting to the expanded setting, wherein the tactile surface 128 at the deformable region 122 is tactilely distinguishable from the tactile surface 128 at the peripheral region 124 in the retracted setting. Generally, the displacement device 130 functions to actively displace fluid through the fluid channel 114 and into the cavity 112 to outwardly expand the deformable region 122, thereby raising the deformable region 122 relative to the peripheral region 124 and/or transitioning the deformable region 122 from the retracted setting to the expanded setting. The displacement device 130 can also actively remove fluid from the fluid channel 114 and the cavity 112 to inwardly retract the deformable region 122, thereby lowering the deformable region 122 relative to the peripheral region 124 and/or transitioning the deformable region 122 from the expanded setting to the retracted setting. The displacement device 130 can further transition the deformable region 122 to one or more intermediate positions or height settings between the expanded and retracted settings. The tactile surface 128 at the deformable region 122 can be flush (e.g., planar) with the tactile surface 128 at the peripheral region 124 in the retracted setting, and the tactile surface 128 at the deformable region 122 can be offset vertically (i.e., elevated above or lowered below) from the tactile surface 128 at the peripheral region 124 in the expanded setting such that the expanded setting is tactilely distinguishable from the retracted setting at the tactile surface 128. Alternatively, the tactile surface 128 at the deformable region 122 can be offset below the tactile surface 128 at the peripheral region 124 in the retracted setting, and the tactile surface 128 at the deformable region 122 can be flush with the tactile surface 128 at the peripheral region 124 in the expanded setting. However, the deformable region 122 can be positioned at any other height relative to the peripheral region 124 in the retracted and expanded settings.

The displacement device 130 can be an electrically-driven positive-displacement pump, such as a rotary, reciprocating, linear, or peristaltic pump powered by an electric motor. Alternatively, the displacement device 130 can be manually powered, such as though a manual input provided by the user, an electroosmotic pump, a magnetorheological pump, a microfluidic pump, or any other suitable device configured to displace fluid through the fluid channel 114, the cavity 112, and/or the fluid conduit 116. For example, the displacement device 130 can be a displacement device described in U.S. Provisional Application No. 61/727,083, filed on 12 Dec. 2012, which is incorporated in its entirety by this reference.

One variation of the user interface 100 further includes a reservoir 132 configured to contain fluid. In one example, the reservoir 132 contains excess fluid, and the displacement device 130 displaces fluid from the reservoir 132 into the cavity 112, via the fluid channel 114, to transition the deformable region 122 from the retracted setting to the expanded setting. In this example, the displacement device 130 can further displace fluid from the cavity 112 into the reservoir 132, via the fluid channel 114, to transition the deformable region 122 from the expanded setting to the retracted setting. Furthermore, in this example, the displacement device 130 can include an electrically-powered, unidirectional, positive-displacement pump coupled to a series of bidirectional valves, wherein valve positions can be set in a first state to actively pump fluid from the reservoir 132 into the cavity 112, and wherein valve positions can be set in a second state to actively pump fluid from the cavity 112 into the reservoir 132. The reservoir 132 can be defined by a second cavity in the substrate 110, or the reservoir 132 can be a discrete component integrated into an electronic device incorporating the user interface 100, such as inside a housing of a mobile computing device. However, the reservoir 132 can be defined in any other suitable way and can be coupled to the displacement device 130 and to the fluid channel 114 in any other suitable way.

The sensor 150 of the user interface 100 is coupled to the substrate and configured to detect an input on the tactile surface 128. The sensor 150 can be a capacitive touch sensor, a resistive touch sensor, an optical touch sensor, a fluid pressure sensor, an acoustic touch sensor, or any other suitable type of sensor, such as described in U.S. patent application Ser. No. 12/975,329, filed on 21 Dec. 2010, U.S. patent application Ser. No. 12/975,337, filed on 21 Dec. 2010, and U.S. Provisional Application No. 61/727,083, filed on 12 Dec. 2012, which are all incorporated in their entirety by this reference.

The sensor 150 can include a set of sensing elements configured to detect an input at particular regions across the tactile surface 128, as described in U.S. Provisional Application No. P25, filed on ??, which is incorporated in its entirety by this reference. In one implementation described above, the sensor 150 can include a set of linear sensing elements patterned along a fourth direction, wherein the first direction is nonparallel with the second direction, the third direction, and the fourth direction, and wherein the second direction is nonparallel with the first direction, the third direction, and the fourth direction. For example, the sensor 150 can be a capacitive touch sensor including a set of electrodes arranged in a linear electrode pattern parallel to the fourth direction, as shown in FIG. 4. In this example, the second direction can be perpendicular to the third direction, the first and second directions can define an included angle of 30°, and the fourth and second directions can define an included angle of 60°. However, the sensor 150 can be of any other type, include any other feature, component, or sensing element, and can be patterned in any other suitable way and in any other suitable direction.

The sensor 150 can be arranged between the display 140 and the substrate 110. Alternatively, the display 140 and the sensor 150 can cooperate to define a touch display (i.e., the display 140 and the sensor 150 can be physically coextensive). A portion of the sensor 150 can also be arranged within the cavity 112, within a portion of the substrate 110 (e.g., above or below the fluid channel 114), or within a portion of the tactile layer 120. However, all or a portion of the sensor 150 and/or one or more sensing elements of the sensor 150 can be arranged in any other way within the user interface 100.

One variation of the user interface 100 includes a second deformable region that cooperates with the substrate 110 to define a second cavity, wherein the second cavity is coupled to a second fluid channel, and wherein the displacement device is coupled to the second fluid channel and is configured to displace fluid through the second fluid channel to transition the second deformable region between a retracted setting and an expanded settings. For example and as shown in FIG. 4, the deformable regions (i.e., the deformable region 122 and the second deformable region) can define discrete input regions when in the expanded settings, wherein each discrete input region is associated with one key of a QWERTY keyboard. In this example, the display 140 can output a first portion of an image aligned with the deformable region 122 and a second portion of the image aligned with the second deformable region, wherein the first portion of the image includes a visual representation associated with the deformable region 122 (e.g., SHIFT, ‘a,’ ‘g,’ or ‘8’), and wherein the second portion of the image includes a visual representation associated with the second deformable region.

Similarly, the tactile layer 120 can include a second deformable region cooperating with the substrate 110 to define a second cavity, wherein the fluid channel 114 defines a second linear segment perpendicular to the linear segment 115. In this example, the second linear segment can be coupled to the linear segment 115 and to the second cavity, and the displacement device 130 can be further configured to displace fluid through the linear segment 115 and through the second linear segment to transition the deformable region 122 and the second deformable region from the retracted setting to the expanded setting, wherein the tactile surface 128 at the second deformable region is tactilely distinguishable from the tactile surface 128 at the peripheral region 124 in the expanded setting. In this example, in the expanded setting, the display 140 can output an image of an alphanumeric keyboard including a first image portion of a first key proximal the deformable region 122 and a second image portion of a second key proximal the second deformable region, wherein the first input key and the second input key are each a unique alphanumeric character of the alphanumeric keyboard. Furthermore, in this example, a processor coupled to the sensor 150 can distinguish an input on the tactile surface 128 at the deformable region 122 and an input on the tactile surface 128 at the second deformable region, thereby capturing serial alphanumeric inputs across expanded deformable regions of the tactile surface 128.

One variation of the user interface 100 includes a processor 160 that handles an input detected on the tactile surface 128 by the sensor 150. The processor 160 functions to handle (e.g., respond to) an input detected on the tactile surface 128. In one implementation, the processor 160 is configured to identify an input of a first type and an input of a second type on the tactile surface 128 at the deformable region 122, wherein the input of the first type is characterized by inward deformation less than a threshold magnitude, and wherein the input of the second type characterized by inward deformation greater than the threshold magnitude. For example, the threshold magnitude can be a threshold change in fluid pressure within the cavity, such as 0.5 psi (3450 Pa), or a threshold deformation distance, such as 0.025″ (0.64 mm). In one example implementation, when the deformable region 122 is in the expanded setting, the processor 160 identifies an input on the tactile surface 128 that substantially inwardly deforms the deformable region 122 as an input request for a capitalized alphabetical key associated with (e.g., displayed adjacent) the deformable region 122, and the processor 160 identifies an input on the tactile surface 128 that does not substantially inwardly deform the deformable region 122 as an input request for a lower-cased alphabetical key associated with the deformable region 122.

One implementation of the user interface 100 is incorporated into an electronic device. The electronic device can be any of an automotive console, a desktop computer, a laptop computer, a tablet computer, a television, a radio, a desk phone, a mobile phone, a PDA, a personal navigation device, a personal media player, a camera, a watch, a gaming controller, a light switch or lighting control box, cooking equipment, or any other suitable electronic device.

As a person skilled in the art will recognize from the previous detailed description and from the figures and claims, modifications and changes can be made to the embodiments of the invention without departing from the scope of this invention as defined in the following claims.

We claim:

1. A user interface comprising:
a substrate defining a fluid channel fluidly coupled to a cavity, the fluid channel comprising a linear segment parallel to a first direction;
a tactile layer comprising a tactile surface, a deformable region cooperating with the substrate to define the cavity, and an peripheral region coupled to the substrate proximal a perimeter of the cavity;
a displacement device coupled to the fluid channel and configured to displace fluid through the fluid channel to transition the deformable region from a retracted setting to an expanded setting, the tactile surface at the deformable region tactilely distinguishable from the tactile surface at the peripheral region in the expanded setting;
a display coupled to the substrate and comprising a set of pixels arranged in a linear pixel pattern parallel to a second direction, the second direction nonparallel with the first direction; and
a sensor coupled to the substrate and configured to detect an input on the tactile surface.

2. The user interface of claim 1, wherein each pixel in the set of pixels comprises a set of color subpixels, each color subpixel in the set of color subpixels configured to output a discrete color of light, wherein a first subset of color subpixels is patterned along the second direction, and wherein a second subset of color pixels is patterned along a third direction nonparallel with the second direction.

3. The user interface of claim 2, wherein each pixel in the set of pixels comprises a red subpixel, a blue subpixel, a green subpixel, and a white subpixel arranged in a rectilinear array.

4. The user interface of claim 2, wherein the first direction bisects the second direction and the third direction.

5. The user interface of claim 2, wherein the sensor comprises a set of linear sensing elements patterned along a fourth direction, wherein the first direction is nonparallel with the second direction, the third direction, and the fourth direction, and wherein the second direction is nonparallel with the first direction, the third direction, and the fourth direction.

6. The user interface of claim 5, wherein the sensor comprises a capacitive touch sensor.

7. The user interface of claim 1, wherein the display defines a gap between two adjacent linear sets of pixels and along a third direction, wherein the first direction is nonparallel to the third direction.

8. The user interface of claim 7, wherein the second direction is perpendicular to the third direction, and wherein the first direction bisects the second direction and the third direction.

9. The user interface of claim 1, wherein each pixel in the set of pixels comprises a rectilinear pixel defining a short face and a long face, wherein the second direction is parallel to the short face of a pixel, and wherein the first direction is parallel to a diagonal across the short face and the long face of a pixel.

10. The user interface of claim 1, wherein the tactile layer comprises a second deformable region cooperating with the substrate to define a second cavity, wherein the fluid channel comprises a second linear segment perpendicular to the linear segment, the second linear segment coupled to the linear segment and to the second cavity, the displacement device further configured to displace fluid through the linear segment and through the second linear segment to transition the deformable region and the second deformable region from the retracted setting to the expanded setting, the tactile surface at the second deformable region tactilely distinguishable from the tactile surface at the peripheral region in the expanded setting.

11. The user interface of claim 10, wherein the display is configured to output a first image of a first key proximal the deformable region and to output a second image of a second key proximal the second deformable region, the deformable region and the second deformable region in the expanded settings, each of the first input key and the second input key comprising a unique alphanumeric character of an alphanumeric keyboard.

12. The user interface of claim 10, further comprising a processor coupled to the sensor and configured to distinguish an input on the tactile surface at the deformable region and an input on the tactile surface at the second deformable region.

13. The user interface of claim 10, wherein the substrate defines the fluid channel that comprises a serpentine fluid channel comprising a set of parallel linear segments connected via perpendicular linear segments.

14. The user interface of claim 1, further comprising a reservoir configured to contain fluid, wherein the displacement device is configured to displace fluid from the reservoir into the cavity, via the fluid channel, to transition the deformable region from the retracted setting to the expanded setting, and wherein the displacement device is further configured to displace fluid from the cavity into the reservoir, via the fluid channel, to transition the deformable region from the expanded setting to the retracted setting.

15. The user interface of claim 1, wherein the tactile surface at the deformable region is substantially flush with the tactile surface at the peripheral region in the retracted setting, and wherein the tactile surface at the deformable region is elevated above the tactile surface at the peripheral region in the expanded setting.

16. The user interface of claim 1, wherein the substrate further defines a support member adjacent the deformable region and configured to support the deformable region against inward deformation in response to a force applied to the tactile surface at the deformable region.

17. The user interface of claim 16, wherein the substrate defines a fluid conduit configured to communicate fluid from the linear segment, through the support member, to the deformable region, and wherein the fluid conduit and a portion of the linear segment cooperate to define the cavity.

18. The user interface of claim 1, further comprising a processor configured to identify an input of a first type and an input of a second type on the tactile surface at the deformable region, the input of the first type characterized by inward deformation less than a threshold magnitude, the input of the second type characterized by inward deformation greater than the threshold magnitude.

19. A user interface comprising:
a tactile layer comprising a tactile surface, a deformable region, and an peripheral region adjacent the deformable region;
a substrate coupled to the peripheral region of the tactile layer, comprising a support member adjacent the deformable region and configured to support the deformable region against substantial inward deformation, defining a fluid channel comprising a linear segment parallel to a first direction, and defining a fluid conduit configured to communicate fluid from the linear segment, through the support member, to the deformable region;
a displacement device configured to displace fluid through the fluid channel to transition the deformable region from a retracted setting to an expanded setting, the tactile surface at the deformable region tactilely distinguishable from the tactile surface at the peripheral region in the expanded setting; and
a display coupled to the substrate and comprising a set of pixels arranged in a linear pixel pattern parallel to a second direction, the second direction nonparallel with the first direction.

20. The user interface of claim 19, further comprising a sensor coupled to the substrate and configured to detect an input on the tactile surface.
